(19) United States
(12) Patent Application Publication
(10) Pub. No.: US 2015/0377173 A1
(43) Pub. Date: Dec. 31, 2015

(54) METHOD FOR CONTROLLING AN INJECTION PROCESS OF A MAGNETIC INJECTOR

(71) Applicant: ROBERT BOSCH GMBH, Stuttgart (DE)

(72) Inventors: Verena TRITSCH, Diez (DE); Olaf Ohlhafer, Erlingheim (DE); Felix Landhaeusser, Notzingen (DE); Peter Boehland, Marbach (DE); Bernd Stuke, Leonberg (DE); Jochen Kuehner, Backnang (DE); Walter Fuchs, Stuttgart (DE)

(21) Appl. No.: 14/768,170

(22) PCT Filed: Jan. 14, 2014
(86) PCT No.: PCT/EP2014/050573

§ 371 Date: Aug. 14, 2015

(30) Foreign Application Priority Data
Feb. 26, 2013 (DE) 10 2013 203 130.0

(51) Int. Cl. F02D 41/30; F02M 51/06

(52) U.S. Cl. CPC F02D 41/3005; F02M 51/061

(57) ABSTRACT

A method for controlling an injection operation of a magnetic injector of an internal combustion engine, the magnetic injector having a coil, the coil being impinged upon by a first current to open the magnetic injector, the coil being short-circuited to hold the magnetic injector open, and the coil being impinged upon by a second current to close the magnetic injector, the second current being directed oppositely to the first current.

### FIELD OF THE INVENTION

The present invention relates to a method for controlling an injection operation of a magnetic injector.

### BACKGROUND INFORMATION

Magnetic injectors, or solenoid injectors, are known and are used in many ways. A usual magnetic injector encompasses a sealing element (also referred to as a “valve needle” or “injector needle”) that interacts with a valve seat and can open up and block a flow path of a fluid. The sealing element is actuated electromagnetically. The magnetic injector encompasses for this purpose an armature that is coupled to the sealing element. The armature, and as a result the sealing element, are pushed by a valve spring into a de-energized end position (“normal position,” “zero position”). In this end position the flow path of the fluid is either blocked (NC) or opened (NO).

By way of an electrical energization of (or application of control to) the solenoid, for example via a so-called “main energization” or “main control application,” an electromagnetic force is generated which moves the armature along with the sealing element against the force of the valve spring. The result of this in turn is that in the case of an NC injector the flow of fluid is enabled, or in the case of an NO injector the flow of fluid is blocked.

When energization of the magnetic injector ends, the magnetic field that holds the armature in the actuated position of the magnetic injector then dissipates. The force of the valve spring counteracting the magnetic field then predominates. This then acts on the armature in such a way that the latter moves away from the solenoid. The result of this in turn is that the valve switches into the unactuated end position.

Delay times occur both between the beginning of energization and movement of the armature, and between the end of energization and arrival at the end position of the armature. The exact opening instant and closing instant of the armature can be identified only with difficulty. These delay times can result in a variation in the volume of fluid passing through the magnetic injector.

Patent document DE 10 2007 045 575 A1 discusses a control application method for magnetic injectors in which provision is made for a preconditioning before opening and a countercurrent clearing after closing.

It is desirable to furnish an energization for a magnetic injector with which a flow rate through the magnetic injector can be regulated more precisely.

### SUMMARY OF THE INVENTION

The present invention provides for a method, having the features described herein, for controlling an injection operation of a magnetic injector. Advantageous embodiments are the subject matter of the further descriptions herein and of the description below.

In a method according to the present invention for controlling an injection operation of a magnetic injector, the magnetic injector having a coil for opening and closing the magnetic injector, during an opening phase the coil is impinged upon by a first current in order to open the magnetic injector. During a so-called “freewheeling” phase, the coil is short-circuited. In a clearing phase the coil is impinged upon by a second current in order to close the magnetic injector. The second current has a direction opposite to the first current.

The invention presents a control application method, in particular for directly switched magnetic injectors, with which they can be actuated particularly quickly. The flow rates through the magnetic injector can be regulated very precisely. In addition, the actual opening instant and closing instant of the magnetic injector can be identified, which results in a further increase in precision. Control of the injection volume becomes more accurate, and the combustion behavior of the internal combustion engine becomes better and less environmentally burdensome.

During the opening phase, a first magnetic field is generated in the coil by the first current. As a result, the magnetic field in the coil rises sufficiently that the armature is lifted out of the seat, i.e. out of the end position. Once the full stroke of the armature has been reached, a lower holding current is all that is needed in order to maintain the armature stroke. For this, in a freewheeling phase the coil is short-circuited, with the result that the current in the coil slowly decreases. This decreasing current is sufficient to maintain the armature stroke, so that the magnetic injector remains open during the freewheeling phase. The provision of a freewheeling phase is suitable in particular for directly switched injectors, in which the valve needle works directly against the fuel pressure (i.e. with no servo-valve functionality), because of the large magnetic forces necessary therein and the correspondingly high coil inductances with a slow current dissipation.

A clearing phase, in which the residual magnetic field present in the coil is reduced by so-called “countercurrent clearing” sufficiently that the magnetic force is less than the sum of the hydraulic forces and spring forces, is provided in order to close the valve. The armature moves back into its end position and the magnetic injector becomes closed. In the clearing phase the magnetic field energy present in the coil is thus actively cleared by countercurrent clearing, i.e. by way of the second current of opposite polarity. Countercurrent clearing is accordingly used to actively close the magnetic injector.

The duration of the clearing phase is usefully selected so that the second magnetic field generated by the second current contributes only to the dissipation of the first magnetic field. It is usually advisable to avoid selecting too long a duration for the clearing phase, and in turn causing magnetic attraction forces between the armature and the coil as a result of the second magnetic field and producing another armature stroke.

The delay time (switching time) between a theoretical and an actual closing instant of the magnetic injector is reduced by the clearing phase. Closing of the magnetic injector is initiated at the theoretical closing instant. With conventional control application with no clearing phase, the applied current is switched off at the theoretical closing instant. It is only after a certain delay time, which is characterized by dissipation of the magnetic field and movement of the armature, that the armature reaches its end position and the injector is actually closed. With control application according to the present invention, the second current is applied at the theoretical closing instant. Thanks to the active magnetic field dissipation by the second current, in accordance with the invention, the magnetic injector closes after a very much shorter delay time. Control application according to the present invention thus allows the injection volume to be regulated more precisely, and the stability of the injection volume in the various injection operations is increased. In addition, during the clearing phase of an injection operation the actuator suite is already moved back into the initial state for the subsequent injection operation.

Advantageously, in the freewheeling phase an actual opening instant of the magnetic injector is identified from the time course of the current flowing through the coil during the short circuit. The movement of the armature induces a first induction current in the coil. Because the coil is short-circuited during the freewheeling phase, this first induction current can be identified. The first induction current is an unambiguous characteristic feature of the opening of the magnetic injector, and an indicator of the actual opening instant of the magnetic injector. Precise detection of the opening instant of the magnetic injector means that the exact beginning of the injection operation is known.

In the clearing phase an actual closing instant of the magnetic injector may be identified from a second induction current. Analogously to the movement of the armature upon opening of the magnetic injector, a second induction current is also induced in the coil by the movement of the armature upon closure of the magnetic injector. As soon as the clearing phase has ended, with the coil short-circuited the second induction current induced by the movement of the armature can be identified. If the coil is not short-circuited after the clearing phase, a corresponding induction voltage can be identified. The second induction current and the induction voltage are an unambiguous characteristic feature of the closing of the magnetic injector, and an indicator of the actual closing instant of the magnetic injector. Precise and reproducible closing of the magnetic injector, as well as accurate detection of the closing instant, are made possible by the active clearing according to the present invention of the magnetic energy from the coil by the countercurrent clearing in the course of the clearing phase.

Advantageously, the duration of an injection operation by the magnetic injector into the combustion chamber of an internal combustion engine is regulated as a function of the actual opening instant and/or the actual closing instant. Accurate detection of the actual opening instant or of the actual closing instant allows the duration of the injection operation, and thus the injection volume, to be precisely identified. The actual opening instant and the actual closing instant can be used as an input variable of a control system, for example in the context of a closed-loop correction. The duration of the injection operation, and thus the injection volume, are regulated in this context, for example, by the fact that a specific actual value of the duration of the injection operation is equalized with a setpoint by adapting control application parameters. The current intensity values of the individual currents, or voltage values of the individual voltages, can be used, for example, as control application parameters. In addition, the actual opening instant and/or the actual closing instant can also be regulated.

In an embodiment of the invention the first current may be generated by a preconditioning voltage, a boost voltage, and a pullup voltage. The opening phase is divided into three phases: a preconditioning phase, a boost phase, and a pullup phase. The first voltage has a different current intensity and a characteristic time course in each of the three phases.

In the preconditioning phase, the preconditioning voltage is applied to the coil. The current rises comparatively slowly, and a magnetic field is built up. The current intensity value or the magnetic force on the armature is not sufficient, however, to move the armature. The actuator system is, so to speak, “preloaded.” The “preloading” of the actuator system allows a delay time between a theoretical and actual opening instant to be reduced, since a weak magnetic field has already been built up and merely needs to be increased for opening.

In the boost phase, the boost voltage is then applied to the coil; this has a larger absolute voltage value than the preconditioning voltage. The current intensity rises comparatively quickly to a maximum value. The magnetic force rises sufficiently that the armature is lifted out of the seat. The maximum force on the armature is required in the boost phase, since the pressure difference at the needle must be overcome in order to open the magnetic injector.

The interaction between the preconditioning phase and boost phase thus on the one hand reduces the delay time or response time of the magnetic injector, i.e. the time between application of the boost voltage and the actual opening instant of the magnetic injector. On the other hand, the energy consumption needed in order to open the magnetic injector is reduced.

The duration of the preconditioning phase can be regulated, for example, as a function of a rail pressure, a vehicle voltage, a magnetic injector temperature, and/or a coil temperature. In a multiple injection context, the duration of the preconditioning phase is additionally dependent on a desired injection interval.

Once the injector needle has lifted off from the seat, the pressure acting on the injector needle rises. The energy expenditure needed in order to maintain a movement of the injector needle thus decreases. A pullup voltage, which has a lower voltage value than the boost voltage, is therefore applied to the coil in the pullup phase.

A full stroke of the armature is not required for smaller injection volumes, for example when the internal combustion engine is being operated at lower rotation speeds. The duration of the preconditioning phase, the boost phase, and the pullup phase can be shortened in accordance with the desired injection volume, and adapted for optimum combustion.

The duration of the individual phases can be adapted in terms of specific measured variables, for example in terms of an energy requirement, an actual value or setpoint of an injection volume, a time course of the injection volume, a rail pressure, an engine rotation speed, or a range of individual measured variables of different injection operations. Thanks to the subdivision of control application to the magnetic injector into three different phases separated from one another (opening phase, freewheeling phase, and clearing phase), in particular the subdivision into five different phases separated from one another (preconditioning phase, boost phase, pullup phase, freewheeling phase, and clearing phase), the injection operation and in particular the injection volume can be controlled much more precisely and accurately. More possibilities and options for corrections and for optimizing the injection operation are also thereby produced.

In a subsequent injection operation of the magnetic injector the coil may be impinged upon by a third current in order to open the magnetic injector, the third current having the same direction as the second current. All the currents, voltages, and magnetic fields of the individual phases of a first injection operation and of a subsequent second injection operation thus each exhibit opposite directions or polarities. In general, all the currents, voltages, and magnetic fields of the individual fields respectively change directions or polarities with each separate injection operation.

The clearing phase of the first injection operation can furthermore contain the preconditioning phase of the second injection operation. This embodiment of the method according to the present invention is particularly suitable for multiple injections with very small injection intervals.

Advantageously, the second current is generated by a clearing voltage that has the same absolute voltage value as the boost voltage. In addition, the preconditioning voltage and the pullup voltage can be identical in terms of absolute value. They can also be generated by the same voltage source, for example a battery of a motor vehicle.

The preconditioning voltage, boost voltage, pullup voltage, and clearing voltage can be adjusted arbitrarily (e.g. pulse width modulation of a constant voltage). The respective voltages of the individual phases, and accordingly the currents of the individual phases, can thus be adjusted individually. The injection operation and the injection volume can thereby be regulated even more precisely.

A calculation unit according to the present invention, for example a control unit of a motor vehicle, is configured, in particular in terms of program engineering, to carry out a method according to the present invention.

Implementation of the method in the form of software is also advantageous, since this results in particularly low costs especially if an executing control unit is also used for further tasks and is therefore present in any case. Suitable data media for furnishing a computer program are, in particular, diskettes, hard drives, flash memories, EEPROMs, CD-ROMs, DVDs, and many others. Downloading of a program via computer networks (Internet, intranet, etc.) is also possible.

Further advantages and embodiments of the invention are evident from the description and from the appended drawings.

It is understood that the features recited above and those yet to be explained below are usable not only in the respective combination indicated, but also in other combinations or in isolation, without departing from the scope of the present invention.

The invention is schematically depicted in the drawings on the basis of exemplifying embodiments and will be described in detail below with reference to the drawings.

### BRIEF DESCRIPTION OF THE DRAWINGS

FIG. 1 schematically depicts, by way of example, a magnetic injector to which control can be applied according to the present invention.

FIG. 2 schematically shows a voltage curve and a current curve respectively at and through a solenoid of a magnetic injector according to an embodiment of the invention.

FIG. 3 schematically shows multiple current curves through a solenoid of a magnetic injector, which are produced by different armature stroke profiles.

FIG. 4 schematically shows a control application circuit for a magnetic injector that is suitable for carrying out an embodiment of a method according to the present invention.

### DETAILED DESCRIPTION

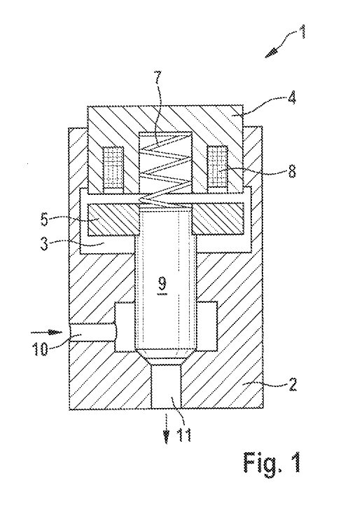

FIG. 1 depicts by way of example a magnetic injector 1 that is closed when de-energized (NC). Magnetic injector 1 has a valve body 2 in which an armature space 3 is embodied. An armature 5 is disposed in armature space 3. Also disposed in armature space 3 is a valve spring 7. Magnetic injector 1 further has a solenoid 8 that annularly surrounds valve spring 7. A magnetic circuit 4 serves as a return path. A sealing element, embodied here as an injector needle 9, is connected to armature 5. Magnetic injector 1 is equipped with an inflow 10 and an outflow 11, although the direction is only exemplifying.

When an electric current is delivered to solenoid 8 via electrical leads (not depicted), a so-called “energization” of magnetic injector 1 occurs. The result is to build up in solenoid 8 a magnetic field that causes a movement of armature 5 upward against the force of valve spring 7. Injector needle 9 consequently lifts off out of the seat, and magnetic injector 1 opens.

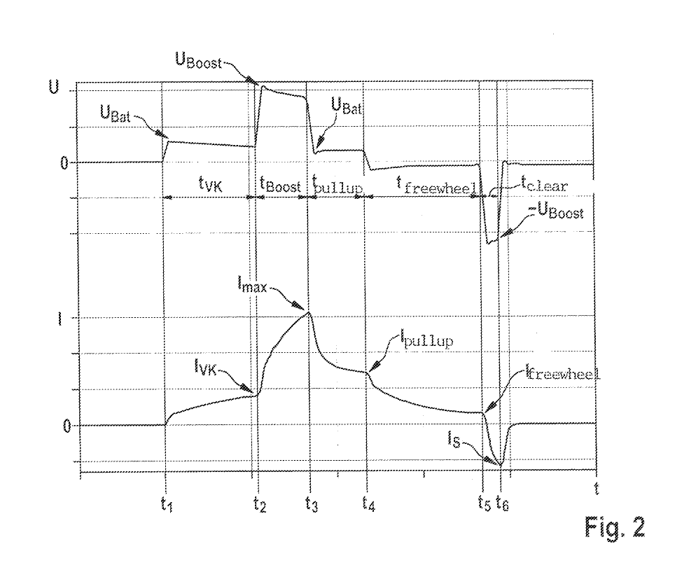

FIG. 2 shows at the top, plotted against time t, a change in the voltage of a control application according to the present invention to a magnetic injector that is present at solenoid 8 of magnetic injector 1. Depicted at the bottom in FIG. 2, plotted against time t, is a curve for a current that flows through solenoid 8 of magnetic injector 1.

At instant t₁, control application to magnetic injector 1 begins with the preconditioning phase t_{VK}. The preconditioning phase t_{VK} takes place between instants t₁ and t₂. As depicted in FIG. 2, for this a battery voltage U_{Bat} is applied to solenoid 8 of magnetic injector 1. As a result, the current through the solenoid rises comparatively slowly from a value of zero to a value I_{VK}.

The current I_{VK} flowing through solenoid 8 causes a magnetic field to build up in solenoid 8. Closing forces, however, in the form of the force of valve spring 7 and the hydraulic force that results from a pressure difference between inflow 10 and outflow 11, continue to predominate. The current I_{VK} is not sufficient to move armature 5 upward.

In the boost phase t_{Boost}, which takes place between instants t₂ and t₃, a boost voltage U_{Boost} is then applied to solenoid 8. The current intensity rises comparatively steeply and reaches a maximum current intensity value Iₘₐₓ within a very short time.

The magnetic field of solenoid 8 rises, and the magnetic force acting in opening fashion on armature 5 exceeds the sum of the forces, in the form of the force of valve spring 7 and the hydraulic forces, acting in closing fashion on armature 5. The armature moves upward, the injector needle uncovers inflow 10 and outflow 11, and magnetic injector 1 is open. The maximum force on the armature is needed in this phase because, as a result of the direct coupling with the injector needle, the entire pressure difference at the injector needle must be overcome for opening.

Once the injector needle has lifted off, the pressure (resulting from throttling of the pressure over the injector needle stroke) acting below the sealing seat of the injector needle rises; this reduces the force required on the injector needle in order to increase the stroke. The force requirement at the magnet armature is thus also reduced, so that the magnetic force and thus the current requirement can be decreased. For this reason, at the end of the boost phase t_{Boost} at instant t₃, the battery voltage U_{Bat} is once again applied to solenoid 8. During this pullup phase t_{Pullup}, which takes place between instants t₃ and t₄, the current intensity decreases from Iₘₐₓ to I_{Pullup}. The magnetic field that is now present in solenoid 8 is still sufficient to open the injector needle further.

These three phases—the preconditioning phase t_{VK}, the boost phase t_{Boost} and the pullup phase t_{Pullup}—together constitute the opening phase. The profile of the current intensity from instant t₁ to instant t₄ represents the first current that impinges upon solenoid 8 in order to open magnetic injector 1.

With the directly switched injectors taken as the basis, no further voltage is needed in order to maintain the opened state. In the next phase (the freewheeling phase t_{Freewheel}) which takes place between the instants t₄ and t₅, solenoid 8 is therefore short-circuited. An external voltage is no longer applied to solenoid 8, and the current intensity of the current flowing through solenoid 8 slowly drops to a value I_{Freewheel}. This comparatively low current intensity is sufficient for armature 5 to hold its position and for magnetic injector 1 to continue to remain open.

In the last phase (the clearing phase t_{clear}) solenoid 8 is impinged upon by a second current in order to close the injector. The clearing phase takes place between instants t₅ and t₆; the polarity-reversed boost voltage −U_{Boost} is applied to solenoid 8. Within a very short time the current flowing through solenoid 8 reverses direction, and the current intensity reaches a value I_{S}. At instant t₆ the negative boost voltage −U_{boost} is disconnected again from solenoid 8.

The second current causes generation of a second magnetic field that is directed oppositely to the original magnetic field (for opening) and actively reduces or clears it. Armature 5 can move back into its end position, and magnetic injector 1 becomes closed.

After instant t₆ it takes only a short time for the solenoid to have no further current flowing through it, and for the current intensity to reach a value of zero. Magnetic injector 1 is now back in its original state.

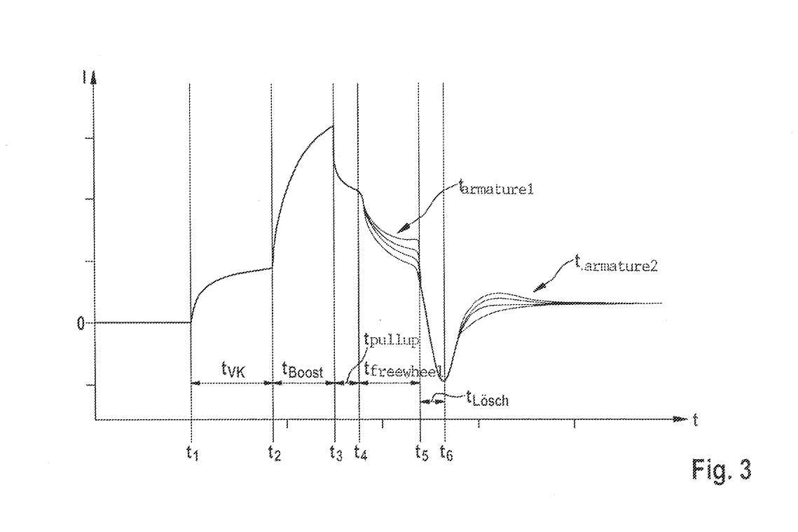

FIG. 3 depicts, analogously to FIG. 2, multiple curves over time t for the currents flowing through solenoid 8 of magnetic injector 1 in the context of an embodiment of a method according to the present invention. The intention of FIG. 3 is to illustrate how a movement of armature 5 can be detected from the time course of the current. In FIG. 3, five time courses of currents during five different injection operations are superimposed. The different current curves are produced by different profiles for the armature stroke.

Because solenoid 8 is short-circuited both during the freewheeling phase t_{Freewheel} and after the clearing phase t_{Clear}, a current induced in solenoid 8 by the movement of armature 5 can be detected in the time course of the current. As is evident from FIG. 3, the five superimposed time courses of the currents at solenoid 8, from five different injection operations in the time intervals t_{Armature1} and t_{Armature2} at which solenoid 8 is short-circuited, are different. By way of a comparison with calibrated curves for the current, it is apparent from these different curves when armature 5 moves and when the magnetic injector is finally closed. If the closing instant is outside a region having negative current intensities, a local maximum in the current curve at the closing instant can additionally be detected and can be evaluated in terms of the closing instant.

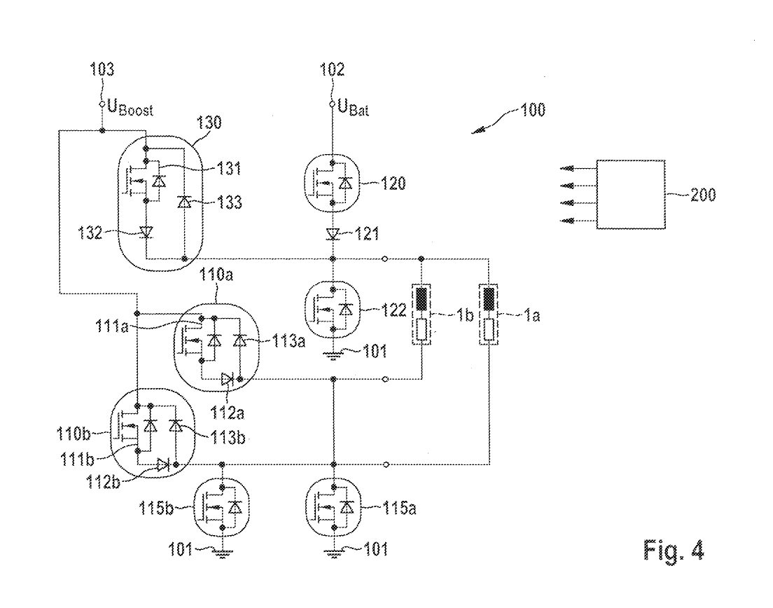

FIG. 4 schematically depicts a circuit diagram of a control application circuit 100 for one or more magnetic injectors, in particular for magnetic injectors 1 according to FIG. 1. Depicted in addition to control application circuit 100 is a calculation unit 200 that is configured in terms of program engineering to carry out an embodiment of a method according to the present invention.

Control application circuit 100 applies control, by way of example, to two magnetic injectors 1a and 1b, where each of the magnetic injectors 1a and 1b can be embodied in accordance with FIG. 1. Each magnetic injector 1a and 1b is respectively connected on the low side to a respective rapid-discharge switching element 110a, 110b. Rapid-discharge switching elements 110 and 110b each have a rapid-discharge transistor 111a, 111b. In the example of FIG. 4, rapid discharge transistors 111a and 111b are embodied as power MOSFETs each having an inverse diode. Rapid-discharge transistors 111a and 111b each have an additional diode pair 112a and 113a, 112b and 113b.

The respective diode 112a, 112b that is connected in series with the corresponding rapid-discharge transistor 111a, 111b blocks a reverse current that can flow as a result of a negative current flow through magnetic injectors 1a and 1b. This reverse current can discharge by way of the respective diode 113a, 113b that is connected in parallel with the corresponding rapid-discharge transistor 111a, 111b. Overvoltage and damage to control application circuit 100 can thereby be prevented.

In addition, each magnetic injector 1a and 1b is connected on the low side to a respective ground switching element 115a, 115b. Magnetic injectors 1a and 1b can be connected to ground 101 by way of the respective ground switching elements 115a and 115b. In the example of FIG. 4, ground switching elements 115a and 115b are each embodied as a MOSFET.

Each magnetic injector 1a and 1b is connected on the high side, via a vehicle electrical system switching element 120 embodied e.g. as a MOSFET and a diode 121, to a pole 102 at which batter voltage U_{Bat} is present. Each magnetic injector 1a and 1b is furthermore connected via a boost switching element 130 to a pole 103 at which the boost voltage U_{Boost} is present. Boost switching element 130 can be embodied, for example, as a MOSFET 130 having an additional diode pair 132 and 133. Diode pair 132 and 133 is embodied analogously to the respective diode pairs 112a, 113a and 112b, 113b of rapid-discharge transistors 111a, 111b.

Lastly, each magnetic injector 1a and 1b is also connected on the high side, via a further ground switching element 122 embodied e.g. as a MOSFET, to ground 101.

Calculation unit 200 is configured to control injection operations in combustion chambers of an internal combustion engine by way of the two magnetic injectors 1a and 1b, and for that purpose correspondingly to apply control to the switching elements of control application circuit 100.

In the preconditioning phase t_{VK}, magnetic injectors 1a and 1b are connected on the high side to battery voltage U_{Bat} by the fact that only vehicle electrical system switching element 120 and ground switching elements 115a and 115b are switched on. A current can thus flow from pole 102 of the battery voltage U_{Bat} through vehicle electrical system switching element 120, through diode 121, through magnetic injectors 1a and 1b, and through ground switching elements 115a and 115b to ground.

For the boost phase t_{Boost}, magnetic injectors 1a and 1b are connected on the high side to boost voltage U_{Boost} by the fact that only boost switching element 130 and ground switching elements 115a and 115b are switched on. Current can thus flow from pole 103 of boost voltage U_{Boost} through MOSFET 131, through diode 132, through magnetic injectors 1a and 1b, and through ground switching elements 115a and 115b to ground.

For the pullup phase t_{Pullup}, analogously to the preconditioning phase t_{VK}, only vehicle electrical system switching element 120 and ground switching elements 115a and 115b are switched on; magnetic injectors 1a and 1b are connected to battery voltage U_{Bat}.

For the freewheeling phase t_{Freewheel}, only ground switching elements 115a and 115b, as well as further ground switching element 122, are switched on. No external voltage is now being applied to magnetic injectors 1a and 1b, and magnetic injectors 1a and 1b are each short-circuited.

For countercurrent clearing in the clearing phase t_{Clear}, magnetic injectors 1a and 1b are connected on the low side to boost voltage. For this, only ground switching element 122 as well as rapid-discharge switching elements 110a and 110b are switched on. Current can thus flow from pole 103 of boost voltage U_{Boost} respectively via rapid-discharge transistors 111a, 111b, diodes 112a, 112b, through magnetic injectors 1a and 1b, and through ground switching element 122 to ground. Current flows through magnetic injectors 1a and 1b in this context in the opposite direction from the boost phase t_{Boost}.

After the clearing phase t_{Clear}, for example, all the switching elements, i.e. in the example of FIG. 4 all the MOSFETs, can be switched off. A residual current can flow out via the freewheeling diodes and decay. Ground switching element 120 as well as ground switching elements 115a and 115b can also be switched on in order to short-circuit solenoids 8 of magnetic injectors 1a and 1b, analogously to the freewheeling phase t_{Freewheel}.

1-12. (canceled)

13. A method for controlling an injection operation of a magnetic injector, having a coil, of an internal combustion engine, the method comprising:
impinging upon the coil a first current to open the magnetic injector;
short-circuiting the coil to hold the magnetic injector open; and
impinging upon the coil a second current to close the magnetic injector, wherein the second current is directed oppositely to the first current.

14. The method of claim 13, wherein an actual opening instant of the magnetic injector is identified from the time course of a first induction current flowing through the coil during short-circuiting.

15. The method of claim 14, wherein the duration of the injection operation is regulated as a function of the actual opening instant.

16. The method of claim 13, wherein the coil is short-circuited after closing of the magnetic injector and an actual closing instant of the magnetic injector is identified from the time course of a second induction current flowing through the coil during short-circuiting.

17. The method of claim 13, wherein the coil is not short-circuited after closing of the magnetic injector, and an actual closing instant of the magnetic injector is identified from the time course of an induction voltage present at the coil.

18. The method of claim 16, wherein the duration of the injection operation is regulated as a function of the actual closing instant.

19. The method of claim 13, wherein upon a subsequent injection operation of the magnetic injector, the coil is impinged upon by a third current to open the magnetic injector, and wherein the third current has the same direction as the second current.

20. The method of claim 13, wherein the first current is generated by a preconditioning voltage, a boost voltage, and a pullup voltage.

21. The method of claim 13, wherein the second current is generated by a clearing voltage that has the same absolute voltage value as the boost voltage.

20. A calculation unit for controlling an injection operation of a magnetic injector, having a coil, of an internal combustion engine, comprising:
a control arrangement to perform the following:
impinge upon the coil a first current to open the magnetic injector;
short-circuit the coil to hold the magnetic injector open; and
impinge upon the coil a second current to close the magnetic injector, wherein
the second current is directed oppositely to the first current.

21. A computer readable medium having a computer program, which is executable by a processor, comprising:
a program code arrangement having program code for controlling an injection operation of a magnetic injector, having a coil, of an internal combustion engine, by performing the following:
impinge upon the coil a first current to open the magnetic injector;
short-circuit the coil to hold the magnetic injector open; and
impinge upon the coil a second current to close the magnetic injector, wherein
the second current is directed oppositely to the first current.

22. The computer readable medium of claim 21, wherein an actual opening instant of the magnetic injector is identified from the time course of a first induction current flowing through the coil during short-circuiting.
